(19) United States
(12) Patent Application Publication
(10) Pub. No.: US 2019/0136086 A1
(43) Pub. Date: May 9, 2019

(54) SILSESQUINOXANE MODIFIED TiO2 SOL

(71) Applicants: DOW GLOBAL TECHNOLOGY LLC, Midland, MI (US); ROHM AND HAAS ELECTRONIC MATERIALS LLC, Marlborough, MA (US)

(72) Inventors: Linfei WANG, Shanghai (CN); Nan HU, Shanghai (CN); Hongyu CHEN, Shanghai (CN); Wanfu MA, Shanghai (CN); Yu CAI, Shanghai (CN); Mitsuru HAGA, Niigata (JP)

(73) Assignees: DOW GLOBAL TECHNOLOGY LLC, Midland, MI (US); ROHM AND HAAS ELECTRONIC MATERIALS LLC, Marlborough, MA (US)

(21) Appl. No.: 16/099,220

(22) PCT Filed: May 27, 2016
(86) PCT No.: PCT/CN2016/083594

§ 371 Date: Nov. 6, 2018

(51) Int. Cl. C09D 183/08; C09D 7/61; C08G 77/28; C08K 3/22; H01B 3/10; H01B 3/46

(52) U.S. Cl. CPC C09D 183/08; C09D 7/61; C08G 77/28; C08K 2003/2241; H01B 3/10; H01B 3/46; C08K 3/22

(57) ABSTRACT

A silsesquinoxane modified TiO₂ sol, a method of forming the TiO₂ sol, a radiation curable composition comprising the TiO₂ sol and cured material formed from the radiation curable composition are disclosed. The TiO₂ sol is at least partially covered by silsesquinoxane and has high RI useful for an insulating layer on indium tin oxide (ITO) electrodes that provides transparency of the ITO electrodes.

### FIELD

The present invention relates generally to silsesquinoxane modified titanium dioxide (TiO₂) sol (fluid suspension of a colloidal solid in a liquid), a method of forming the TiO₂ sol, a radiation curable composition comprising the TiO₂ sol and a material formed from the radiation curable composition. In particular, the present invention relates to TiO₂ sol in which the TiO₂ is at least partially covered by silsesquinoxane having a thiol group. The TiO₂ sol provides high refractive index (RI) materials useful for insulating coating materials on electronic components such as indium tin oxide (ITO) electrodes.

### INTRODUCTION

Electronic components are normally covered by organic coating materials to prevent them from its oxidation or corrosion. ITO has been used as transparent electrodes on touch screen panels, and also coated by organic coating materials. Normally, ITO electrodes are mounted on a glass substrate, then an insulating material is applied over the surface of the ITO electrodes as their protective layer. Typically, an acrylic or polysiloxane type polymer composition is used for insulating layers of ITO electrodes, but these insulating layers often make ITO electrodes visible. The reason is that refractive indices (RI's) of these insulating layers (1.3-1.5) and RI of ITO (1.6-1.8) are quite different, and the difference in RIs causes strong light reflection on the interface between the insulating layer and ITO, making ITO electrodes visible. The light reflection greatly reduces light transmittance of displays and causes correspondingly lower visual performance of the displays. Therefore, an insulating layer with RI at the same or quite similar level of the RI of ITO's is desired.

TiO₂ is added in insulating layer compositions to increase RI of the insulating layers. Some prior art references disclose siloxane polymer compositions comprising TiO₂, for example, US8,318,885B, JP3995173B, US7,393,469A, US7,582,358B and US20110262750A.

### SUMMARY

The present invention provides silsesquinoxane modified TiO₂ sol with sufficient high RI for the use of insulating layers on ITO electrodes and a method for forming the TiO₂ sol.

One aspect of the invention relates to a composition comprising a particle having a center part and an outer part surrounding the center part at least partially, in which the center part comprises titanium oxide and the outer part comprises silsesquinoxane having a thiol group.

In another aspect, the invention relates to a method of forming the composition comprising the steps of: (a) condensating a composition comprising titanium precursor to form a particle comprising titanium oxide, and (b) contacting the particle with alkoxysilane having a thiol group.

In yet another aspect, the invention relates to a reaction product obtained from the steps of: (a) contacting titanium alkoxide with an acid to form a titanium oxide particle, and (b) contacting the titanium oxide particle with alkoxysilane having a thiol group.

In further aspect, the invention relates to an organic film comprising the particle. The film is formed on an object.

In yet further aspect, the inventions relate to a radiation curable composition comprising (a) the particle and (b) a compound having an ethylenically unsaturated group and a material formed from the radiation curable composition.

### BRIEF DESCRIPTION OF THE DRAWINGS

FIG. 1 is the Dynamic Light Scattering (DLS) curve of TiO₂ particles obtained in Example 1.

FIG. 2 is the DLS curve of TiO₂ particles obtained in Example 2.

### DETAILED DESCRIPTION

The TiO₂ sol of the present invention comprises a particle which has a center part and an outer part. The center part comprises TiO₂. TiO₂ of the invention is a three dimensional polymer having —Ti—O—Ti— bond structure. The center part is formed by hydrolysis and condensation reaction of a compound comprising a titanium precursor. Examples of the titanium precursor include, but are not limited to, tetra alkyl titaniums such as tetra isopropyl titanium, tetrabutoxy titanium, tetraethoxy titanium, and tetramethoxy titanium. The center part can comprise other metal oxides such as zirconium oxide or hafnium oxide in addition to titanium oxide.

The center part is at least partially surrounded by an outer part. The outer part comprises silsesquinoxane which has a thiol group. The thiol group is functioned to an alkyl group of the silsesquinoxane. Therefore, the silsesquinoxane which has a thiol group is also called as “thiol functionalized silsesquinoxane” in the present application. The thiol functionalized silsesquinoxane used in the invention is preferably a hydrolytic condensation composition of formula (1): R¹R²Si(OR³)₂, wherein R¹ and R² are independently selected from aliphatic or aromatic hydrocarbon groups having from 1 to 8 of carbon atoms and thiol groups. At least one of R¹ and R² has at least one thiol group. R³ is selected from aliphatic or aromatic hydrocarbon groups having from 1 to 8 of carbon atoms. Examples of the formula (1) compound include, but are not limited to, 3-mercaptopropylmethyldimethoxysilane, 3-mercaptopropylmethyldiethoxysilane, 3-mercaptopropylmethyldipropoxysilane, 3-mercaptopropylmethyldibuthoxysilane, 2-mercaptoethyl methyldimethoxysilane, 2-mercaptoethyl methyldiethoxysilane, 2-mercaptoethyl methyldipropoxysilane, 2-mercaptoethyl methyldibuthoxysilane and 1,2-dimercaptoethyltrimethoxysilane. Those mercaptosilanes can be used as a mixture thereof. Those compounds can be obtained in public.

In addition to the above compounds trialkylalkoxysilanes such as trimethylmethoxysilane, trimethylethoxysilane, triethylmethoxysilane, triethylethoxysilane, triphenylmethoxysilane and triphenylethoxysilane; dialkyldialkoxysilanes such as dimethyldimethoxysilane, dimethyldiethoxysilane, diethyldimethoxysilane, diethyldiethoxysilane, diphenyldimethoxysilane, diphenyldiethoxysilane, methylphenyldimethoxysilane and methylphenyldiethoxysilane; alkyltrialkoxysilanes such as methyltrymethoxysilane, methyltriethoxysilane, ethyltrimethoxysilane, ethyltriethoxysilane, phenyltrimethoxysilane and phenyltriethoxysilane; trialkylalkoxysilanes such as trimethylmethoxysilane, trimethylethoxysilane, triethylmethoxysilane, triethylethoxysilane, triphenylmethoxysilane and triphenylethoxysilane can be used to adjust the crosslink density and/or the contents of thiol groups of the thiol functionalized silsesquinoxane. Those compounds can be obtained in public.

The center part is at least partially covered by thiol functionalized silsesquinoxane. The percentage of its coverage can be controlled from the ratio of TiO₂ precursor with thiol functionalized silsesquinoxane.

The content of TiO₂ in the particle is preferably 60 weight percent (wt %) or more, more preferably 70 wt % or more based on the weight of the particle.

Sizes of the particles have a distribution. The sizes of 80% of the particles are from 2 to 150 nm. Preferably, the sizes of 80% of the particles are from 2 to 100 nm, more preferably, from 2 to 50 nm. The size can be measured by dynamic light scattering (DLS) method using for example, Malvern Zetasizer Nano ZS at room temperature.

A method for forming the TiO₂ sol includes following two steps: (a) condensating a composition comprising titanium precursor to form titanium oxide (TiO₂) particle, and (b) contacting the TiO₂ particle with alkoxysilane having thiol groups.

The first step is condensating a composition comprising titanium precursor to form TiO₂ particle. Normally, a solution comprising titanium precursor, water and acid is prepared. Preferably, titanium precursor is titanium alkoxyde. The concentration of the titanium precursor is from 150 to 400 g/L, preferably from 200 to 350 g/L, more preferably from 250 to 300 g/L based on the solution. Acid can be organic acid or inorganic acid. Examples of acid include, but are not limited to, hydrochloric acid, sulfuric acid, formic acid and acetic acid. Acid helps hydrolysis reaction of the titanium alkoxyde. The concentration of the acid is from 2.5 to 12.0 g/L, preferably from 4.5 to 8.5 g/L based on the solution. A base can be used instead of an acid. The solution optionally comprises a solvent such as methanol, ethanol or butanol. The solution is heated at 30 to 80° C., preferably 60 to 80° C. under stirring for hydrolysis and condensation reaction. Reaction time is from 1.5 hours to 5 hours, preferably from 3 to 4 hours. As the condensation reaction is proceeding, the size of TiO₂ dispersoid becomes bigger. The reaction is also known as sol-gel reaction. When TiO₂ particles with required sizes are obtained, the first step is finalized.

The second step is contacting the TiO₂ particle with alkoxysilane having a thiol group. Preferable alkoxysilane is dialkoxysilane. Examples of dialkoxysilane having a thiol group include, but are not limited to, 3-mercaptopropylmethyldimethoxysilane, 3-mercaptopropylmethyldiethoxysilane, 3-mercaptopropylmethyldipropoxysilane, 3-mercaptopropylethyldimethoxysilane, 3-mercaptopropylethyldiethoxysilane and 3-mercaptopropylethyldipropoxysilane. The weight ratio of titanium precursor with alkoxysilane having a thiol group is from 1:1 to 4:1, preferably from 2:1 to 4:1. The ratio is decided from the required thiol group content and RI of the obtained SiO₂ sol. Normally, TiO₂ particle is contacted with alkoxysilane having a thiol group under stirring. Reaction temperature is from 25 to 65° C., preferably from 50 to 65° C. Reaction time is from 1 to 4 hours, preferably from 2 to 3 hours.

Obtained reaction product is cooled to room temperature, then optionally left (aged) for 12 to 24 hours. Optionally, the solvent of the reaction product is exchanged to another solvent which is used to radiation curable compositions. Examples of the solvent used for radiation curable compositions include, but are not limited to, propyleneglycol monomethyl ether (PGME), propylene glycol phenyl ether propyleneglycol monomethyl ether acetate (PGMEA), 1-propoxy-2-propanol, ethyl lactate, methyl 2-hydroxyisobutyrate and cyclohexanone.

An organic film comprising the TiO₂ sol of this invention can be formed on an object. Any objects can be used. Examples of the objects include, but are not limited to, plastics, metals, glass and electronic components such as ITO electrodes, wiring materials and glass or silicon substrates. A composition comprising TiO₂ sol can be coated on an object by any known methods such as spin coating. Optionally the composition is dried to evaporate solvent. The RI of the organic film comprising the particle is from 1.65 to 2.0. Preferably, the RI of the film containing the particle is from 1.7 to 1.9.

A radiation curable composition of this invention comprises (A) a TiO₂ sol disclosed above and (B) a compound having an ethylenically unsaturated group. Examples of the compounds having an ethylenically unsaturated group include, but not limited to, tryallylcyanurate, tryallyl isocyanurate, tryallyloxy-1,3,5-triazine, tetrallyl pentaerythrirol ether and tryallyl glycerol ether. The amounts and ratio of (A) the TiO₂ sol and (B) the compound having an ethylenically unsaturated group is decided from the molar ratio of thiol groups of the TiO₂ sol and carbon-carbon double bonds of the compound having an ethylenically unsaturated group. The molar ratio of thiol groups of the TiO₂ sol over the carbon-carbon double bonds of the compound having an ethylenically unsaturated group (thiol groups of the TiO₂ sol/carbon-carbon double bonds of the compound having an ethylenically unsaturated group) should be from 0.2 to 2.0, preferably the molar ratio is from 0.3 to 1.1.

The radiation curable composition can further comprise a photoinitiator (PI). Any known photoinitiators such as oxime ester type photoinitiators, alkylphenone type photoinitiators and cationic type photoinitiators such as sulfonium salts or iodonium salts can be used. Examples of the PI include, but are not limited to, Irgacure OXE-01, Irgacure OXE-02, Irgacure 379, Irgacure 651, Irgacure 127 and Irgacure 907.

The amount of a PI in the composition is from 0.001 to 3.0 wt % based on the total weight of the TiO₂ sol and the compound having an ethylenically unsaturated group. Preferably, the amount of the PI is from 0.01 to 1.0 wt %, more preferably from 0.1 to 0.5 wt % based on the total weight of the TiO₂ sol and the compound having an ethylenically unsaturated group.

The radiation curable composition can further comprise at least one solvent. Examples of solvents include, but are not limited to, propyleneglycol monomethyl ether (PGME), propylene glycol phenyl ether propyleneglycol monomethyl ether acetate (PGMEA), 1-propoxy-2-propanol, ethyl lactate, methyl 2-hydroxyisobutyrate and cyclohexanone. The total amounts of solvents are from 25 to 900 wt % based on the total weight of the TiO₂ sol and the compound having an ethylenically unsaturated group. Preferably, the total amounts of solvents are from 150 to 400 wt % based on the total weight of the TiO₂ sol and the compound having an ethylenically unsaturated group.

The radiation curable composition can be applied to electronic components. Any known methods can be used for applying the composition on electronic components. Examples of the methods include spin-coating, roll-coating and spraying the composition on electronic components, or dipping electronic components in the composition.

Then the composition is exposed to a radiation to crosslink the thiol group of the TiO₂ sol and the ethylenically unsaturated group of the compound having an ethylenically unsaturated group. Exposure can be conducted by UV light, for example, using 300 to 400 nm of light and total exposure amount with 50 to 10,000 mJ/cm². Exposure is conducted with use of a pattern mask to obtain needed pattern on electronic components. Then, unexposed area is washed away by a developing composition called as developer. Examples of the developer include, but are not limited to, alkaline solutions comprising potassium hydroxide, sodium hydroxide, tetramethylammonium hydroxide and tetrabutylammonium hydroxide. Optionally, the exposed compound can be further heated to 20 to 80° C. for 1 minute to 24 hours.

After exposure, the radiation curable composition is cured and forms a hardened material. The hardened material can be used for forming insulation layer (organic coating) on electronic components. Examples of the electronic components include, but are not limited to, ITO electrodes and wiring materials of the ITO electrodes used for LCD devices, OLED devices and touch screen sensor panels. Wiring materials include copper, silver and metal alloy containing copper or silver. The organic coating formed from the composition in the invention has higher RI, so that it is especially useful to for insulating layers on ITO electrodes.

### EXAMPLES

Raw materials shown in Table 1 were used in Examples.

TABLE 1

| Chemical name | Function | Technical features | Provider |
|---|---|---|---|
| Titanium(IV) | monomer | reagent grade, | Sigma Aldrich |
| isopropoxide | | 97.0% | |
| 3-Mercaptopropyl | ligand | reagent grade, | TCI Co., Ltd. |
| methyldimethoxy- | | 98% | |
| silane | | | |
| 3-Mercaptopropyl | ligand | reagent grade, | TCI Co., Ltd. |
| Trimethoxy- | | 98% | |
| silane(KH550) | | | |
| Anhydrous Ethanol | solvent | reagent grade, | Sinopharm |
| | | 98.5% | Chemical |
| | | | Reagent Co. |
| concentrated | catalyst | 35-37% HCl acid | Sinopharm |
| hydrochloric acid | | | Chemical |
| | | | Reagent Co. |
| Tryalylisocyanurate | monomer | — | Nippon Kasei |
| | | | Chemical |
| | | | Co. LTD |
| Irgacure-279 | Photo | — | BASF |
| | Initiator | | |
| Propylene glycol | Solvent | 99.5% | Sinopharm |
| monomethyl ether | | | Chemical |
| (PGME) | | | Reagent Co. |
| propyleneglycol | Solvent | — | Nippon Nyukazai |
| monomethyl ether | | | Co. LTD. |
| acetate (PGMEA) | | | |

### Example 1 (Inventive Example)

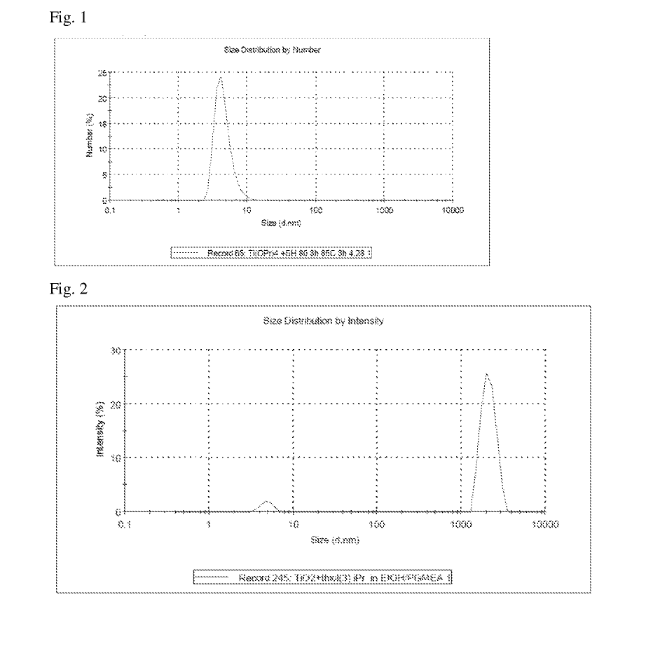

Titanium(IV) isopropoxide (28.4 g) and ethanol (40 g) were mixed in a vessel and transferred into a three-neck flask with a magnetic stirring bar. The temperature of the mixture was increased to 80° C., then a mixture of HCl solution (14.2 g of 1 mol/L in EtOH), water (3.6 g) and ethanol (40 g) was slowly added into the flask by an injection pump. After the addition, the solution was stirred for 3 hours. A transparent TiO₂ solution was obtained. Then, the temperature was dropped to 65° C. 3-mercaptopropylmethyldimethoxysilane (5.24 g) was added into the solution. The solution was stirred for 3 hours under 65° C. After that, the solution was cooled down to room temperature. The solution was aged for 15 hours at room temperature and the solvent was exchanged by PGME. The TiO₂ particles were dispersed in PGME, forming a visually translucent, pale yellow solution with solid content of 25 wt %. The formed TiO₂ solution was dispersed in ethanol, then sizes of the TiO₂ particle was measured by Dynamic Light Scattering (DLS, Malvern Zetasizer Nano ZS) at room temperature. DLS curve was shown in FIG. 1.

The TiO₂ particles in PGME (solid content is 25 wt %) was diluted into 15 wt % by PGME, then casted onto glass sheet by spin coating. Solvent was evaporated, then a transparent film with 0.9 micron thickness was obtained. Refractive Index (RI) of the film at 550 nm was measured using ellipsometer. The RI value was 1.70. Transparency of the film was analyzed by ultraviolet-visible (UV) spectrophotometer. The light transmittance was 96% at 550 nm and 88% at 365 nm.

### Example 2 (Comparative Example)

The same process as of Example 1 was conducted excepting for 5.67 g of 3-mercaptopropyltrimethoxysilane (KH550) was used instead of 3-mercaptopropylmethyldimethoxysilane. After aged for 15 hours, the TiO₂ was aggregated and white solids were precipitated. The synthesized TiO₂ sol is not stable enough. DLS curve was shown in FIG. 2.

### Examples 3-5

Compositions comprising the TiO₂ sol obtained in Example 1, triallylisocyanurate, Irgacure-279 (photo initiator) and solvent were prepared. The ratio of the TiO₂ sol with tryallylisocyanurate were 60/40 by weight for Example 3, 80/20 by weight for Examples 4 and 5. The solvent was a mixture of PGMEA and PGME with 20/80 by weight, and the amount of photo initiator was 0.3 wt % based on the total weight of the TiO₂ and the tryallylisocyannurate. The molar ratio of thiol group of the TiO₂ by allyl group of tryallylisocyanurate was 25/75 for Example 3, and 47/53 for Examples 4 and 5. The solid contents were 0.29.

The compositions were spin-coated on a glass substrate. Spin speed was adjusted to obtain 1.8 μm of film thickness after soft bake process. 90° C. of soft bake was applied for 120 seconds on proximity hot plate of the coating tool. Film thickness was measured by light interference method (Lambda-A VL-M6000-LS, Screen). For Examples 3 and 4, the coated substrates were baked and cured at 120° C. (hard bake) in a convection oven for 60 minutes. For Example 5, expose and develop steps were conducted before hard bake. The coated substrate was exposed by broad band proximity exposure tool (MA-1200, Dainippon Kaken) with 600 mJ/cm² of exposure dose. Integrate exposure energy was measured by i-line sensor (UV-M03A, Orc Manufacturing Co.,). To obtain photo patterns, a photo mask (Multitone testpattern mask, Benchmark Technologies) was used. After exposure process, the substrate was developed by 2.38 wt % TMAH (tetramethylammonium hydroxide) aqueous solution for 60 seconds. After water rinse and spin dry processes, 120° C. of hard bake cure was applied in a convection oven for 60 minutes. Refractive Indices of the obtained films at 500 nm, 550 nm and 600 nm (wavelength) were measured using ellipsometer. The values are shown in Table 2.

TABLE 2

| Wavelength (nm) | Example 3 | Example 4 | Example 5 |
|---|---|---|---|
| 500 | 1.698 | 1.743 | 1.678 |
| 550 | 1.687 | 1.730 | 1.721 |
| 600 | 1.678 | 1.721 | 1.698 |

What is claimed is:

1. A composition comprising a particle having a center part and an outer part at least partially surrounding the center part, in which the center part comprises titanium oxide and the outer part comprises silsesquinoxane having a thiol group.

2. The composition of claim 1, wherein the content of titanium oxide is 60 weight % or more based on the weight of the particle.

3. The composition of claim 1, wherein the diameters of at least 80% of the particles are from 2 to 150 nm measured by the dynamic light scattering method.

4. A method of forming the composition of claim 1 comprising the steps of
(a) condensating a composition comprising titanium precursor to form a particle comprising titanium oxide, and
(b) contacting the particle with alkoxysilane having a thiol group.

5. The method of claim 4, wherein the alkoxysilane is dialkoxysilane.

6. The method of claim 4, wherein the titanium precursor is titanium alkoxyde.

7. The method of claim 4, wherein the weight ratio of titanium precursor with alkoxysilane is from 1:1 to 4:1.

8. A reaction product obtained from the steps of:
(a) contacting titanium alkoxide with an acid to form titanium oxide particle, and
(b) contacting the titanium oxide particle with alkoxysilane having a thiol group.

9. An organic film formed on an object, comprising a particle having a center part and an outer part at least partially surrounding the center part, in which the center part comprises titanium oxide and the outer part comprises silsesquinoxane having a thiol group.

10. The organic film of claim 9, wherein the refractive index of the film is from 1.65 to 2.0.

11. A radiation curable composition comprising (A) a particle having a center part and an outer part at least partially surrounding the center part, in which the center part comprises titanium oxide and the outer part comprises silsesquinoxane having a thiol group and (B) a compound having an ethylenically unsaturated group.

12. A material formed from the radiation curable composition of claim 11.
